(19) United States
(12) Patent Application Publication
(10) Pub. No.: US 2018/0096415 A1
(43) Pub. Date: Apr. 5, 2018

(54) Guided Communication Using Wrap Packages of Cards

(71) Applicant: BrunoCo, Inc., San Francisco, CA (US)

(72) Inventors: John M. Garris, San Francisco, CA (US); Peter Petras, San Francisco, CA (US); Eric T. Jeffries, Alamo, CA (US)

(21) Appl. No.: 15/725,211

(22) Filed: Oct. 4, 2017

Related U.S. Application Data
(60) Provisional application No. 62/403,923, filed on Oct. 4, 2016.

(51) Int. Cl. G06Q 30/06; G06Q 20/12; G06Q 30/02

(52) U.S. Cl. CPC G06Q 30/0641; G06Q 30/0269; G06Q 20/12

(57) ABSTRACT

Systems and methods for are provided herein. Exemplary methods include receiving data input from an input device, the data input including identification of a target recipient and one or more content titles; selecting, responsive to receiving the data input, one or more cards, from a library of cards, pertinent to the one or more content titles; assembling the wrap package of cards, the wrap package of cards including the one or more cards selected from the library of cards and personalized with content pertinent to the identified target recipient; generating a document descriptor that represents the wrap package of cards; and providing, using a communication network, the document descriptor to a computing device associated with the target recipient, the document descriptor being used by the computing device to generate a runtime instance of the wrap package of cards.

### CROSS REFERENCE TO RELATED APPLICATIONS

This application claims the benefit of U.S. Provisional Application No. 62/403,923, filed Oct. 4, 2016, the disclosure of which is incorporated by reference for all purposes.

### TECHNICAL FIELD

This invention relates to the creation and delivery of personalized marketing content and e-commerce related services, and more particularly, to an automated system and method for the guided selling of goods or services by automatically delivering wrap packages of electronic cards, each customized with personalized content for a target recipient.

### BACKGROUND

With regard to the consumption of media today, there are several overwhelming trends. First, people are now spending more and more time on the Internet, while consuming less and less traditional media, such as television, printed newspapers, periodicals, magazines, etc. Second, more and more commerce is migrating from “bricks and mortar” establishments to online retailers. As a result, most businesses today, including both brick and mortar and dedicated e-commerce companies, maintain an online presence that enables customers to navigate to their web site and make online purchases. Third, of the time spent on the Internet, the trend now clearly favors mobile devices over desktop or laptop computers. The growth of mobile consumption is now far outpacing non-mobile and this trend is likely to continue well into the future. As a result of a convergence of these factors, more and more companies are focusing on a “mobile-first” strategy, meaning they are attempting to make their online presence on mobile devices as user-friendly as possible.

Although the value of a mobile-first strategy is clearly recognized, the problem is that the conventional methods for distributing content over the Internet, namely web sites and other static documents, such PDF files, were developed for the desktop paradigm. As a result, the user experience in consuming such content on mobile phones, for example, is typically less than ideal.

With mobile, there are a number of issues with web sites. First, web sites are essentially “portals,” meaning a viewer is typically required find the web site before viewing can begin. Web sites are thus not a “deliverable” object that can be electronically transported to a target recipient. Second, web sites are typically “generic”, meaning they are for viewing by a wide audience. Web sites, therefore, are typically not personalized for a particular viewer. As a result, it is often difficult for a retailer to convey a “bite-size” marketing story or narrative within the context of a web site that is personalized for a particular viewer. Third, viewing web pages on a mobile phone is often a very frustrating experience. Individual web pages and text are difficult to read due to small screen sizes. Navigating from page to page is also troublesome because it is difficult to select navigational links with a finger, again due to the small screen sizes.

In another alternative, retailers will often create PDFs to distribute product catalogs and other marketing materials. While PDFs often provide a compelling visual experience on mobile devices, their functionality is limited. PDFs are static documents, meaning they are not interactive. As a result, online transactions through a PDF file are not possible. In addition, PDFs are typically large block files, which makes them difficult to distribute and download over wireless networks to mobile phones.

To mitigate the aforementioned problems, e-retailers and other businesses with an online presence have resorted to developing mobile-specific web sites and/or mobile application or “apps”. While both of these measures offer advantages, they are still problematic.

With mobile-specific web sites, the viewing experience is typically user friendlier than non-mobile specific web sites. However, as web pages, they are still plagued with the above-described issues on mobile devices. Furthermore, the cost and complexity of creating and supporting multiple versions of a given website is beyond the resources of many small businesses.

With apps, viewers can view content in an environment that is typically more user-friendly compared to conventional web sites. Apps, however, have their own host of issues. First, like web sites, apps are typically “generic” and are developed for a wide audience. As a result, it is difficult to customize an app for a particular viewer, meaning a personalized user experience is typically difficult to provide via an app. Second, apps are difficult to build, requiring a sophisticated level of software expertise to develop. In addition, apps are typically “walled-gardens,” meaning they are difficult, (although not impossible) to integrate with other platforms, such as an e-commerce platform. Also, for a given app, multiple versions are normally required since a distinct version is required for each mobile platform (e.g., Apple iOS, Google Android, etc.). In addition, apps are typically distributed through third parties, such as the Apple App Store or the Google Play Market. Finally, if a target recipient has not downloaded an app onto their phone or other mobile device, the distributor cannot contact and distribute content to that recipient through the app.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to various methods and systems for compensating for irregular motion in three-dimensional spectroscopy. Specifically, a method for generating and delivering an electronic document defining a wrapped wrap package of cards may comprise: receiving data input from an input device, the data input including identification of a target recipient and one or more content titles; selecting, responsive to receiving the data input, one or more cards, from a library of cards, pertinent to the one or more content titles; assembling the wrap package of cards, the wrap package of cards including the one or more cards selected from the library of cards and personalized with content pertinent to the identified target recipient; generating a document descriptor that represents the wrap package of cards; and providing, using a communication network, the document descriptor to a computing device associated with the target recipient, the document descriptor being used by the computing device to generate a runtime instance of the wrap package of cards.

### BRIEF DESCRIPTION OF THE DRAWINGS

Embodiments are illustrated by way of example, and not by limitation, in the figures of the accompanying drawings, in which like references indicate similar elements and in which:

FIG. 1 is a guided selling system for creating and delivering personalized wrap packages to target recipients in accordance with a non-exclusive embodiment of the present invention.

FIG. 2 is a block diagram depicting a wrap environment for creating wrap packages in the guided selling system in accordance with a non-exclusive embodiment of the present invention.

FIG. 3A through FIG. 3C are non-exclusive examples of user interfaces used in the guided selling system in accordance with different embodiments of the present invention.

FIG. 4 is an exemplary wrap package template used in the guided selling system in accordance with a non-exclusive embodiment of the present invention.

FIG. 5 is a flow diagram illustrating the steps implemented in the guided selling system for the creation and delivery of a personalized wrap package to a target recipient in accordance with a non-exclusive embodiment of the present invention.

FIG. 6 is diagram illustrating how cards are selected from a card library in the creation of a personalized wrap package.

FIG. 7A is a diagram illustrating how personalized content is generated within the guided selling system in accordance with a non-exclusive embodiment of the present invention.

FIG. 7B is diagram illustrating how cards are selected from a card library in the creation of a personalized wrap package in accordance with another embodiment of the present invention.

FIG. 8 is an exemplary user interface device used in the guided buying system of the present invention.

FIG. 9A and FIG. 9B illustrate an exemplary personalized wrap package generated by the guided buying system of the present invention.

FIG. 10 illustrates a block diagram of a wrap package descriptor and a runtime engine in accordance with a non-exclusive embodiment of the present invention.

FIG. 11 illustrates a block diagram including one or more components used to represent a non-gallery card in accordance with a non-exclusive embodiment of the present invention.

FIG. 12 illustrates a block diagram including one or more components used to represent a gallery card in accordance with a non-exclusive embodiment of the present invention.

FIG. 13 illustrates a representative wrap package in accordance with a non-exclusive embodiment of the present invention.

In the drawings, like reference numerals are sometimes used to designate like structural elements. It should also be appreciated that the depictions in the figures are diagrammatic and not to scale.

### DETAILED DESCRIPTION

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

### Overview of Wrap Packages

The present disclosure is directed to the mechanisms that support the distribution of media content, and a corresponding palette of application functionality and/or e-commerce related services, in the form of wrapped packages of cards (interchangeably referred to herein as a “wrap,” “package” or “wrap package”).

A wrap package, which includes a set of cards arranged in one or more predefined sequences, is a unique delivery mechanism for the distribution of authored content and functionality. Wraps are typically characterized by the following:

(a) Each card is selectively authored to include media, such as text, photos, images, video, documents, etc. Since the cards are arranged in their one or more sequences, the multi-media can be authored to convey a “story telling” narrative that unfolds as the cards are sequentially browsed;

(b) The cards of wraps can also be selectively authored to include web or application like functionality;

(c) The cards of a wrap all have a defined presentational aspect ratio (typically, but not necessarily, a portrait view);

(d) The layout of the content of any particular card is fixed or immutable. That is, the positional relationship between the displayed components of any given card remains the same within the given aspect ratio of the card, regardless of the size, width, height, or type of display on which the wrap is rendered;

(e) Wraps are designed for, although not limited to, mobile. On mobile devices having touch sensitive screens, the cards of wraps are navigated by swipe browsing.

Wraps thus mimic the way people already use their smartphones and other mobile devices such as tablets. Every swipe reveals a new card with a “bite-size” message and/or content.

As the cards are sequentially swiped during consumption, the story-telling narrative of the wrap unfolds. In addition, the user experience in viewing a given wrap is almost always the same, regardless of the type of viewing device, since the sequence of the cards is defined and each card is immutable and maintains its defined aspect ratio at runtime.

In certain non-exclusive embodiments, wraps are authored using a template-based authoring tool that requires little to no technical expertise. Wraps can, therefore, be simply and inexpensively created, allowing online retailers and others to promote and deliver their brand, products and/or interactive services through the web with an ease previously not possible. Up to now, developing apps or web sites typically required a high degree of software sophistication, significant cost, and took months or weeks to create. Now with wrap, businesses and other content providers can inexpensively create, with little software expertise, interactive wrap packages in hours or minutes.

Another advantage of wraps is that they do not require a dedicated infrastructure for distribution and viewing. By using wrap identifiers, such as URLs, wraps can be distributed to a specific individual or widely to many, either by including the wrap identifiers in messages (e.g., emails, texts, etc.), by posting in social media feeds (e.g., Facebook, Twitter, etc.), and/or embedding in online advertisements, etc. This attribute, meaning the ability to easily share and distribute wraps over already pervasive communication channels, is likely to increase the possibility of (i) wraps in general becoming ubiquitous in the mobile economy and (ii) individual wraps going “viral”.

Consumers now spend vast amounts of their on-line time and consciousness on their mobile phones and tablets. As a result, the ability to easily distribute wraps to mobile devices helps brands intimately deliver elegant, user experiences, precisely where it matters the most. Wraps thus have the ability to transform mobile devices into powerful business tools. By delivering wraps to mobile devices, it helps brands sell more and build recognition, relationships and loyalty among customers.

In one non-exclusive embodiment, wraps are platform agnostic because all that is needed to view a wrap is a browser. When a wrap is requested for viewing, a runtime viewer is provided along with a wrap descriptor. On the consuming device, the runtime viewer is arranged to de-serialize the cards of the wrap descriptor and to generate a runtime instance of the wrap. In other embodiments, the runtime viewer may already be included in a native application residing on the consuming device.

Wraps are thus a groundbreaking, mobile-first, storytelling and ecommerce platform. By making it simple, inexpensive and easy to (i) author narrative wraps with interactive functionality and (ii) to distribute wraps like messages, wraps have the unique ability to:

(a) “democratize” the web by providing a powerful, low barrier, low cost alternative to apps and web sites;

(b) unlock the vast story-telling potential of the Internet, and

(c) drive e-commerce by building customer relationships and increasing web conversion rates via the interactive functionality provided in wraps.

Wraps thus solve many of the problems and limitations associated with the existing methods for distributing content and conducting e-commerce, such as PDF files, web sites, dedicated apps, and the like. With all these benefits, wraps have the potential of becoming ubiquitous, ushering in a new paradigm referred to herein as the “Narrative Web”.

### Guided Selling System Using Personalized Wrap Packages

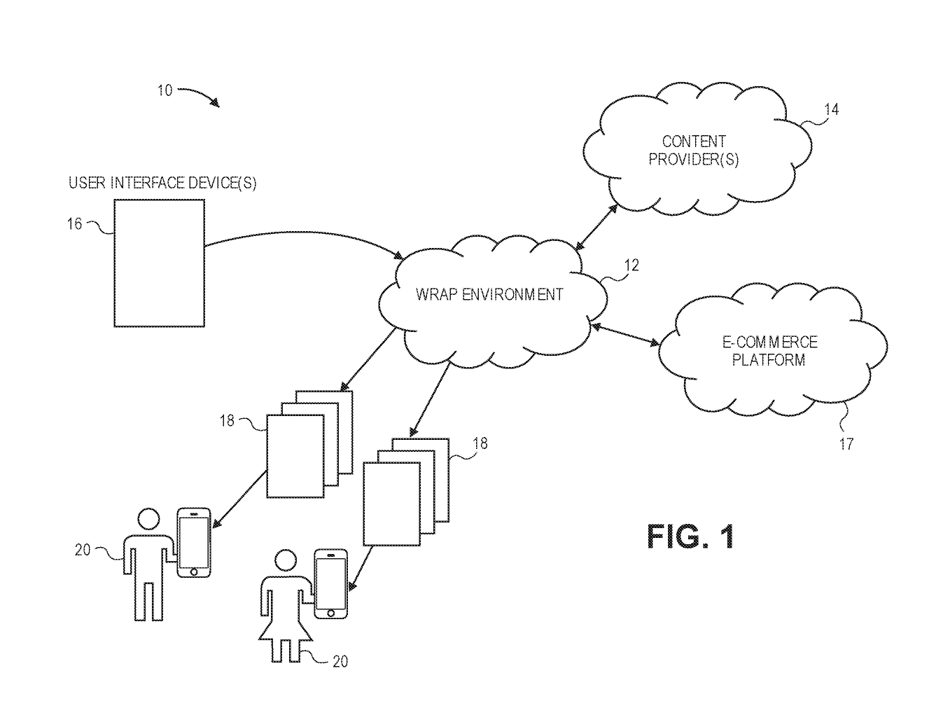

Referring to FIG. 1, a non-exclusive embodiment of a guided selling system 10 for the automated authoring, personalization and delivery of wrap packages to target recipients is illustrated. In this embodiment, the system 10 includes a wrap environment 12, one or more content providers 14, one or more user interface device(s) 16, and optionally an e-commerce platform 17. During operation, as described in detail below, one or more of the user interface devices 16 is/are used in cooperation with the wrap environment 12 to automatically generate and distribute wrap packages 18, each with custom content personalized for various target recipients 20.

The wrap environment 12 provides a number of tools and services within the guided selling system 10. These tools and services, which are described in greater detail below, include a wrap authoring tool, a set of Application Programming Interfaces (APIs) for interfacing with the wrap environment 12, a demographics rule engine for defining personalized content for target recipients 20, and an analytics tool for tracking views and the overall effectiveness of wrap packages 18.

The content provider(s) 14 are the entities interested in distributing content to target recipients in the form of wrap packages 18. In various non-exclusive embodiments, content providers 14 can be just about any type of organization interested in distributing media content and/or online services, such as but not limited to, businesses, enterprises, online retailers, bricks and mortar retailers, educational institutions, non-profit organizations, etc. It should be understood that this list is merely exemplary and should not be construed as exhaustive. Any organization, person or entity interested in distributing media content and/or web services or functionality may be a content provider 14 within the system 10.

The user interface devices 16 are typically hardware devices that provide a screen to present to a viewer a number of content title options and input tool(s) for selecting one or more of the content title options and for receiving target recipient identification information. Examples of user interface devices 16 may include, but are not limited to, mobile phones, tablet computers, laptop computers, desktop computers, kiosks, or just about any other type of computer device capable of displaying information and receiving data inputs. During operation, a user interface device 16 is used to capture (i) identification information of a target recipient 20 and (ii) one or more content titles the target may be interested in. This information is then provided to the wrap environment 12, where it is used as described in detail below, to generate and deliver a personalized wrap package 18 to the target 20. In various embodiments, the person interacting with a given user interface device 16 may be either the target recipient, a representative of a content provider 14, or just about any other party or entity.

The optional e-commerce platform 17 provides an e-commerce infrastructure that enables the purchase of goods and/or services presented within personalized wrap packages 18. For example, a given content provider 14 may maintain within the platform 17 a database of product and/or service items it may wish to market and promote using wrap packages 18, an inventory management system that tracks the sale and restocking or such items, and a payment gateway that defines payment methods and processes payment transactions for the purchase of product and/or service items purchased through wraps 18. For more details on the ecommerce platform 17, see U.S. Provisional Application No. 62/366,433, incorporated herein for all purposes.

### The Wrap Environment

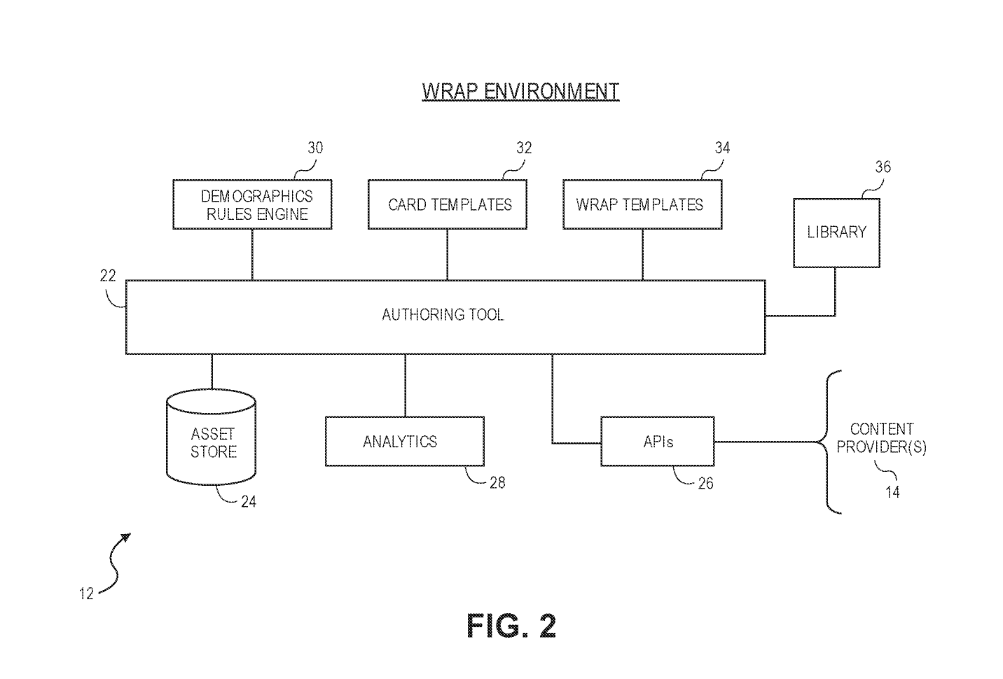

Referring to FIG. 2, a block diagram depicting the wrap environment 12 in accordance with a non-exclusive embodiment of the present invention is illustrated.

The wrap environment 12 includes an authoring tool 22 for authoring wrap packages 18 (FIG. 1) and an asset store 24 for storing assets, such as images, photos, video, and other content that may be inserted or otherwise associated with cards of wrap packages. In general, the authoring tool 22 empowers an author to create a wrap package by (i) selecting a card type among a plurality of card types (e.g., a text card, an image/photo card, a commerce card, a gallery card, etc.), (ii) select a card template among a plurality of card templates of the selected card type, the templates having different layouts, styles etc., (iii) creating a new card by copying the selected card template; (iv) authoring the new card with content and/or functionality, (iv) repeating steps (i) through (iii) to create multiple cards and then (v) defining a sequence order for rendering the cards in horizontal and/or vertical direction(s). Once a wrap has been authored, the authoring tool generates a wrap descriptor, including card descriptors specifying the layout and content for each card. For more details on the authoring tool 22, see for example U.S. patent application Ser. No. 14/740,539 and U.S. patent application Ser. No. 14/993,829, both of which are incorporated by reference herein for all purposes.

A set of Application Programming Interfaces (APIs) 26 define the protocols that enable the content provider(s) 14, the user interface device(s) 16 and the e-commerce platform 17 (FIG. 1) to communicate with the wrap environment 12. APIs generally include methods of communication between various software components. These API protocols define, for example, how the authoring tool 22 can be accessed and how cards and wrap packages 18 can be created, accessed, shared, deleted, etc. For example, APIs can be used to create a card collection with a specific title (e.g., the “Spring Collection” or the “Holiday Season Collection”), search and identify different card collections, search and identify all the cards in a given collection, delete or rename a given card collection, add or delete cards from a given collection, etc. The APIs can also be used to access individual cards or a group of cards. For example, APIs can be used to search, delete, clone, return, etc. one or more cards meeting a specified search criteria or card ID(s). At the wrap level, APIs can be used to create a wrap using card IDs, generate a list of wraps meeting certain search criteria, delete, copy, rename, publish, etc., wraps using wrap IDs, add, delete, rearrange, personalize, etc. individual cards in a given wrap, or share a given wrap using the wrap ID, etc. Any of these functions named herein, along with a wide variety others functions not listed, can be accessed, implemented and controlled using APIs. It should be understood that these specific examples should in no way be construed as limiting and that any function, either at the individual card level, group of cards level, or wrap level, can be performed via APIs.

An analytics tool 28 is provided for measuring and analyzing the performance of wrap packages 18. For example, the tool 28 may ascertain how much time target recipient(s) 20 spend consuming a given wrap package 18, which type of cards in a wrap package 18 is/are consumed or not consumed, what products and/or service items are purchased or not purchased within given wrap 18, etc. By examining such data, conclusions and intelligent inferences can be made regarding the content and type of products and/or service items that should be included in a given wrap package 18. In addition, decisions or inferences can also be made about certain generalities of wraps that make them more effective, such as the number of cards in a given wrap, the types of cards that are most compelling or least compelling, the preferred type of card to use first or last in a wrap, etc. Analytics can also be applied at the card level as well. Such analytics can be used to make intelligent choices regarding cards to make them more appealing and effective, such as the best or most pleasing layout of content, location of a “BUY” button, the ideal information to include in a card, etc. Analytics can also be used to determine when it is the best time that a wrap should be generated and delivered. For example, if analytical data indicates that wraps sent out at particular days of the week, or at a particular time of the day, are viewed more often, then intelligent decisions can be made as to when wraps are created and delivered to target recipients 20. These are just of few examples of the intelligent decisions or inferences that can be made using the analytics tool 28. It should be understood that the analytics tool 28 can be used to analyze just about any characteristic or feature of a wrap package and the few examples provided herein should not be construed as limiting.

A demographics rule engine 30 is responsible for tracking and maintaining demographic information personal to each of the target recipients 20. Such demographic information may include, but is not limited to, the age, gender, geographic location, vertical-affinity, past viewing history and/or past buying history.

In non-exclusive embodiments, the demographics rule engine 30 helps define the selected cards and/or content that should be included in a particular wrap package 18 that has been personalized for a target recipient 20. For example, the cards, products and/or service items included in a given wrap for an age 25 female student, located in Los Angeles, with a past history of buying shoes, will be very different than an age 50 male businessman, located in Chicago, with a history of purchasing suits and other business attire.

The wrap environment 12 further includes a card template store 32 for storing various card templates and a wrap template store 34 for storing wrap package templates. As explained in more detail below, the card templates are used to create a set of cards that are maintained in a library 36. The wrap package templates, which each define a number, type, layout and sequence of cards, serve as “blueprints” for the creation of personalized wrap packages 18 that are delivered to target recipients 20.

In non-exclusive embodiments, it may also be beneficial to include card templates in card template store 32 that are optimized for commerce. Such “commerce” cards could include, for example, a presentation optimized for the advertisement of a product or service item, including content component containers for inclusion in the card of an image of a product or service, a title/name of the product or service, a purchase price, a product or service description, product/service availability, a popularity index, and other commerce-related attributes. Such cards may also include built-in functionality and/or services for the processing of electronic transactions, such as widgets, feeds, shopping carts, etc.

Again, these are just a handful of possible examples of the types of card templates that can be maintain in card template store 32 that are used to create cards maintained in the library 36. In actual embodiments, an almost infinite number of card type templates, an infinite variety of wrap package templates, and cards may be maintained in storage elements 32, 34 and 36 respectively. Thus, an almost infinite variety of personalized wrap packages 18 can be distributed to target recipients 20.

### User Interface Device Examples

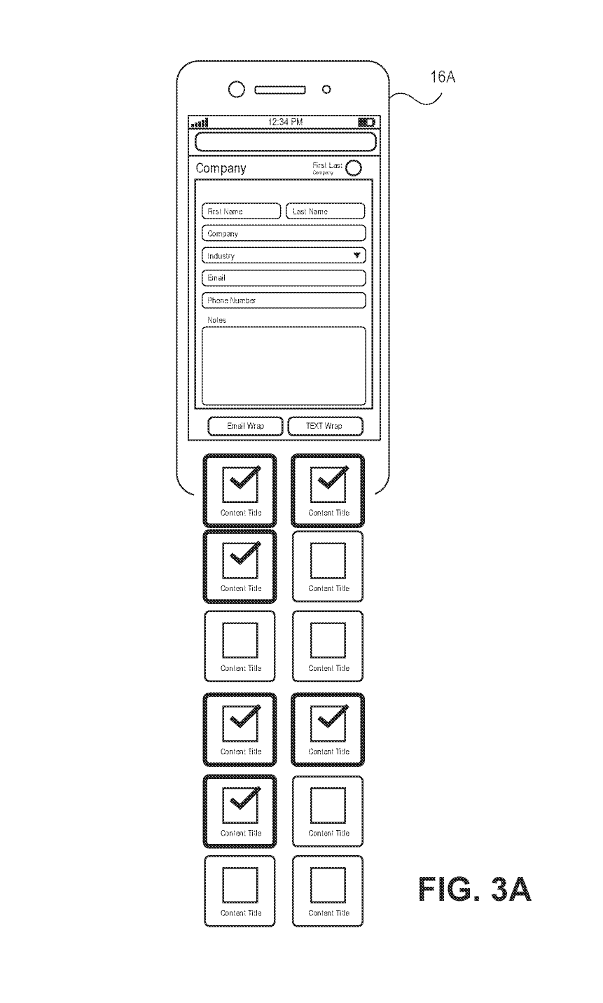

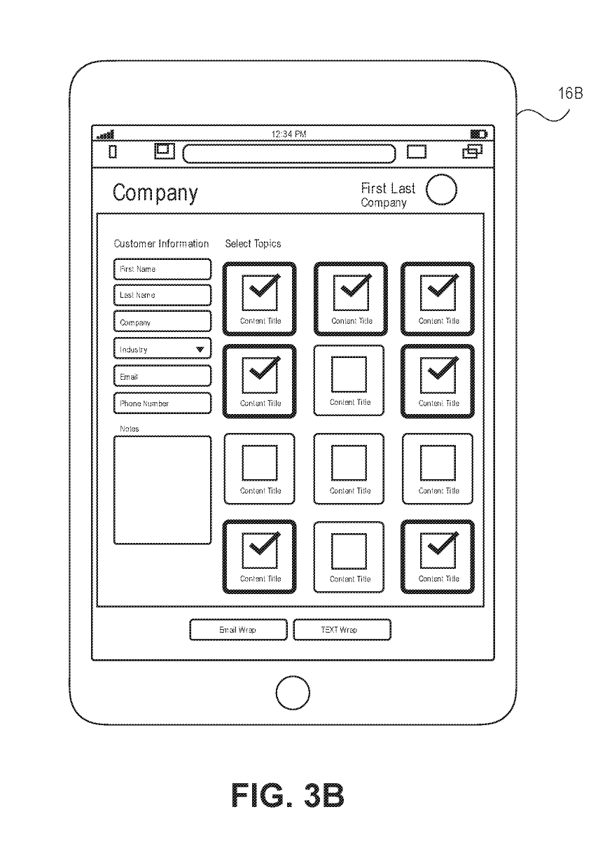

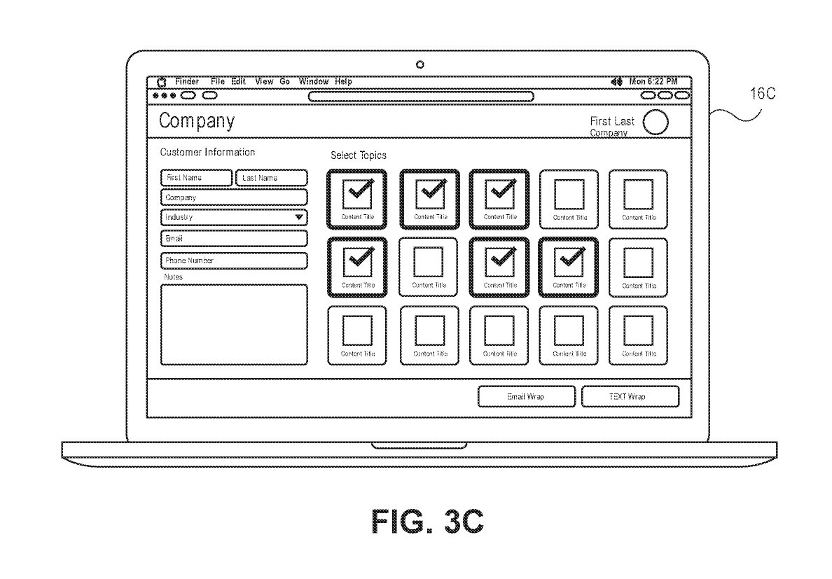

Referring to FIG. 3A through 3C, several examples of user interface devices 16 (FIG. 1) are illustrated. In particular, FIG. 3A shows a mobile phone 16A, FIG. 3B shows a tablet computer 16B, and FIG. 3C shows a laptop computer 16C. In each embodiment, the device 16 includes a display screen including (i) one or more text entry fields for capturing information pertinent to a target recipient 20, such as their name, company, industry, email address, phone number, etc.; (ii) icons for specifying a delivery preference of a wrap package 18 via either email using the entered email address or by text message using the entered telephone number; and (iii) a menu list of selectable content titles.

With each of these embodiments, data entry with devices 16A through 16C is in compliance with standard operating procedures for each. For example, with the mobile phone device 16A and the tablet 16B, text is entered using a virtual keyboard and selections are entered via a touch screen using a selection device, such as a finger or stylus. In FIG. 3C, a keyboard and mouse can be used for text entry and selections for content titles and/or wrap delivery methods. The embodiments shown in FIGS. 3A through 3C are merely exemplary. It should be understood that any computer device, whether currently known or developed in the future, that enables the data input of information pertinent to a target recipient 20, a delivery preference, and the selection of one or more content titles may be used.

It should also be understood that a wide variety of persons or entities may operate a given user interface device 16, depending on circumstances. For instance:

In one scenario, the person operating a user interface device 16 may be a customer representative for a content provider 14 (FIG. 1). When a customer calls into or visits the center, the representative may ask the customer for their contact information (e.g., named, company, email, telephone number, etc.) and product or service items (e.g., content titles) of interest. As the information is received, the representative enters it into the user interface device 16 (FIG. 1). In response, a personalized wrap package 18 (FIG. 1) is created and delivered, as described in detail below, to a computing device (e.g. a mobile phone, tablet, laptop computer) belonging to the customer (i.e., a target recipient 20) using their phone number and/or email address.

In another scenario, the device 16 (FIG. 1) may belong to the target recipient 20 (FIG. 1). For example, the target recipient may be planning a shopping trip to the local mall. Prior to arrival at the mall, the target recipient may access the web site of their favorite retailer at the mall using their mobile phone. Via a web page provided by the retailer, the target recipient can enter their aforementioned contact information, content title selection(s) (e.g., the summer collection, special promotions, women's shoes, etc.), and delivery preference. In response, as described below, a personalized wrap package 18 (FIG. 1) is created and delivered to the same mobile phone or other device associated with the recipient using the preferred delivery method.

In yet another scenario, a target recipient may be viewing a particular web page. While viewing, a pop-up window may appear prompting the target recipient to enter the above-defined input data. In response, a personalized wrap package 18 (FIG. 1) is created and delivered.

In yet another scenario, a content provider 14 (FIG. 1) may set up a kiosk at a trade show, retail store or other public location. As people walk by, interested parties can enter their contact, content title selections and preferred delivery method through the kiosk. In response, personalized wrap packages 18 are created and delivered to the interested parties.

It should be noted that the above-defined data input does not necessarily always have to be physically entered by a human. On the contrary, in alternative embodiments, the data input is machine defined. For example, if a target recipient is browsing a particular web page belonging to or associated with a particular content provider, then either the web server hosting the web site, a cloud infrastructure associated with the web site, the target recipient's computer, or a combination thereof, may be responsible for generating or inferring the target identification information and content titles.

For example, a target recipient may have an online account with an online retailer, such as Amazon.com. If the target happens to be browsing particular type of product (e.g., stereo headphones), then Amazon may generate and deliver a personalized wrap 18 (FIG. 1), specific to headphones, using already known account information (e.g., name, phone number, email address, etc.) of the target recipient.

Alternatively, the web site may generate a pop-up window while the target is browsing a particular web site. In the pop-up window, the target may be prompted to enter contact information and possibly one or more content titles.

In another alternative, the content titles may be inferred based on the subject matter of the web site. For example, if the web site belongs to the Ford Motor Company and the particular web pages being viewed pertain to hybrid cars, then it can be inferred that the content title pertains to hybrid vehicles and a personalized wrap directed to the same can be generated and delivered.

Based on the few illustrative examples provided herein, it should be understood that the terms data and data input should be broadly construed to cover a wide variety of situations, including when such data is generated by a human, inferred, or defined by a computing device associated with either the target recipient, a web site, a cloud computing infrastructure, and/or a content provider 14 (FIGS. 1 and 2), or any combination thereof.

Furthermore, it should be understood that the content titles can widely vary, but are typically applicable to a given content provider 14 (FIGS. 1 and 2) that is interested in distributing personalized wrap packages 18 to target recipients 20. For example, if the content provider 14 is a telecom company, then the content titles will typically be related to different types of mobile phones and mobile data and telephone service plans. Alternatively, if the content provider is a department store, then the content titles will be applicable to products and/or services offered by the retailer, such as a holiday collection, back to school specials, summer sale, etc. If the content provider 14 is an automobile company, then the content titles may pertain to topics such as their compact cars, SUVs, sedans, safety features, etc. The above describes just a handful of examples. It should be understood that the topics and/or subject matter addressed or otherwise identified using content titles, whether explicitly defined or inferred, is virtually limitless and the examples provided herein should not be construed as limiting in any manner.

### Wrap Package Templates

Prior to the creation and delivery of personalized wrap packages 18, a wrap package template is first created. In a non-exclusive embodiment, a content provider 14 (FIGS. 1 and 2) may create one or more wrap package template(s) using the wrap environment 12. For example, the content provider may access the authoring tool 22 (FIG. 2) and author a wrap package template that includes a predetermined number and type of cards and one or more rendering sequence orders.

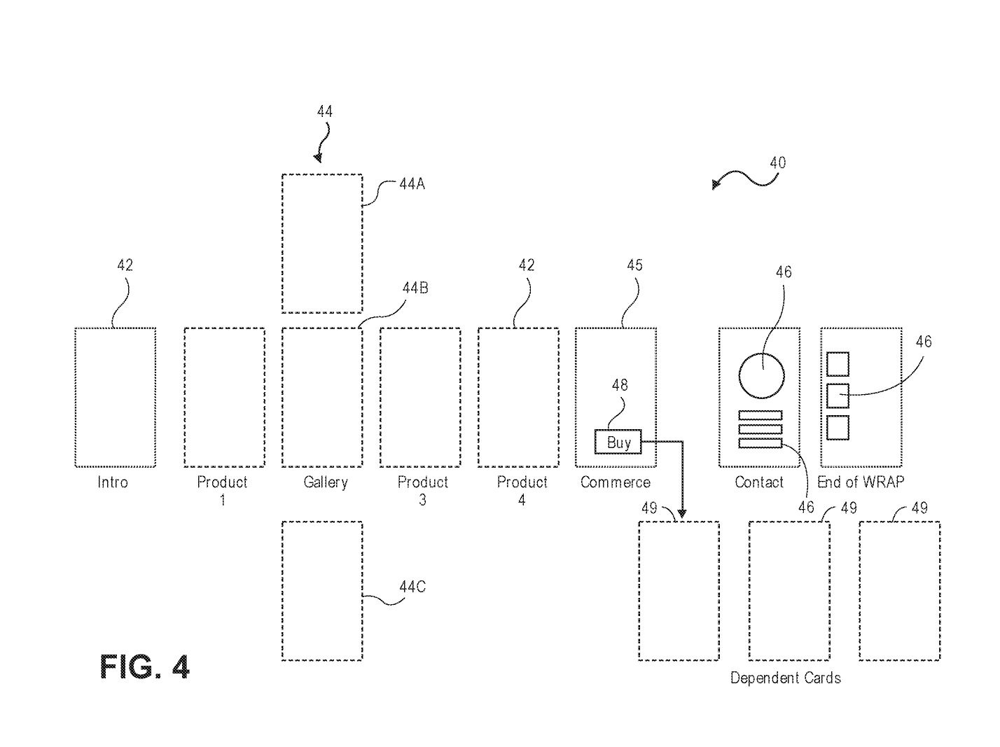

Referring to FIG. 4, an exemplary wrap package template 40 is illustrated. In this particular example, the wrap package template 40 includes a number of cards 42 arranged in a horizontal sequence. Of these, the cards 42 are organized by type, including (from left to right) an introduction card, three product cards, a commerce card 45, a contact card, and finally, an end of wrap card. A gallery card 44 is also included in this example. In this instance, the gallery card has three gallery frames 44A through 44C that are arranged in a vertical sequence. With this arrangement, the cards of any wrap 18 (FIG. 1) that is derived from this particular wrap template 40 will be navigable along the horizontal and vertical directions in response to navigable inputs provided to the rendering computing device when the wrap is consumed.

Certain cards of the wrap package template 40 may also include empty content component containers 46. These empty content component containers 46 are typically, although not necessarily, arranged to contain customized content specific to a target recipient 20 when a wrap package is generated.

In this example, the commerce card 45 of the template 40 includes a “BUY” trigger 48. When a wrap 18 (FIG. 1) is generated from the template 40, the BUY trigger 48 embodies certain predefined capabilities for the resulting card to cooperate with the e-commerce platform 17 to implement purchase transactions of products and/or services. In various embodiments, the predefined capabilities may be a widget arranged to communicate with a remote widget e-commerce server maintained within the platform 17 (FIG. 1) or elsewhere, a call-to-action button that results in the cul-de-sacing (e.g., changing, switching, transferring, forwarding, routing, and the like from one card/resource/document to another) to a remote web site maintained in the platform 17 or elsewhere for processing an ecommerce transaction, or a trigger to one or more dependent cards 49 that are arranged to cooperate with the platform 17 to implement a typical e-commerce flow, such as a shopping cart, prompting entry of a shipping address, credit card or other payment options, a preview of an order, and once the order is complete, an electronic receipt or confirmation of the transaction.

Once the wrap template 40 is created, it can be maintained in the wrap template store 34 (FIG. 2). As described below, the template 40 serves as a “blueprint” for the creation of personalized wrap packages 18 (FIG. 1) that are sent to target recipients 20 (FIG. 1).

The particular arrangement and sequence of cards of the wrap package template 40 as described and illustrated herein in merely exemplary and provided for illustrative purposes. It should be understood that a wide variety of wrap package templates may be used including any number and/or types of cards, sequence orders, content containers, triggers and/or functionality. By providing a wide assortment of different cards in the library 36 (FIG. 2) and wrap templates 40 in the wrap template store 34 (FIG. 2), content providers 14 have the ability to define personalized wrap packages 18 (FIG. 1) having different presentations and including subject matter, triggers and/or functionality covering, addressing or applicable to just about any content title imaginable.

### Creating and Delivering Personalized Wrap Packages

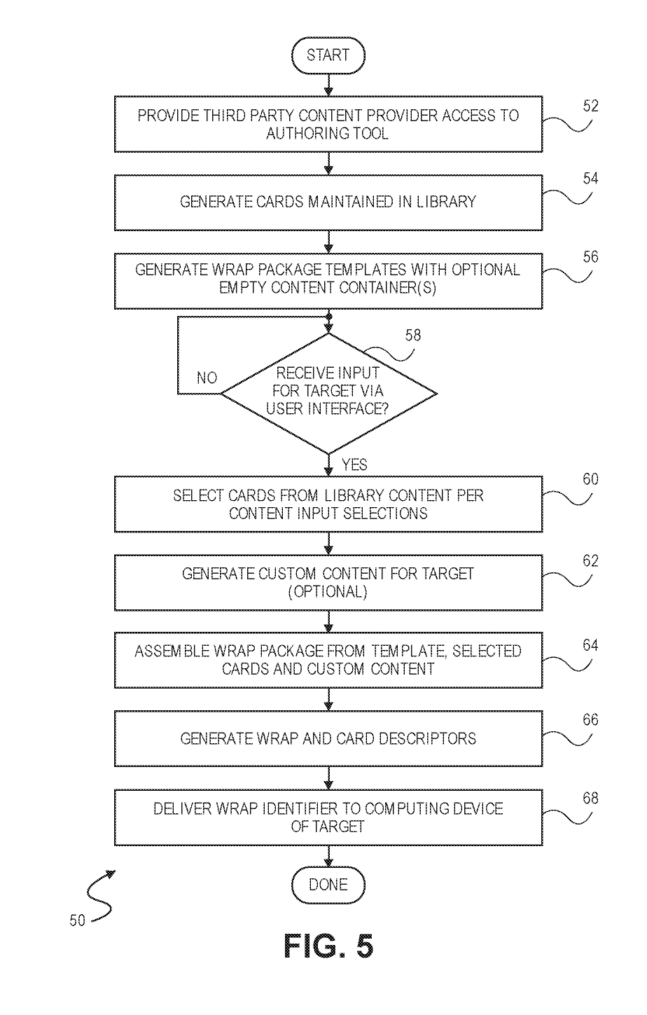

Referring to FIG. 5, a flow diagram 50 illustrating the steps for the creation and delivery of personalized wrap packages 18 (FIG. 1) to target recipients 20 (FIG. 1) on behalf of a content provider 14 (FIGS. 1 and 2) is illustrated.

At the initial step 52, the content provider 14 (FIGS. 1 and 2) can access the authoring tool 22 (FIG. 2) in wrap environment 12 (FIGS. 1 and 2). In a non-exclusive embodiment, the authoring tool 22 is made available using a “Software as a Service” (SaaS) model. In other embodiments, the authoring tool is an application that is distributed to or otherwise made available to the content provider 14.

At step 54, the content provider 14 (FIGS. 1 and 2) can create a number of cards from the one or more card templates maintained in the card template store 32 (FIG. 2). Once the cards are created, they can be stored in the library 36.

The cards created by the content provider 14 (FIGS. 1 and 2) may widely vary. For example, if the content provider 14 is a retailer, then the created cards will likely be product (or service) cards that present the products and services offered by the retailer. In one non-exclusive embodiment, product and/or service item information can be uploaded from a database (not illustrated) to the wrap environment 12 (FIGS. 1 and 2) using the defined APIs 26. The uploaded information is used to populate the selected card templates. In this particular example, uploaded information may include, but is not limited to, an image or photo of each offered product/service item, a SKU number for each product or service item, the cost of each item, aspects for each item (e.g., different sizes, colors, materials, etc.), shipping details, or just about any other type of relevant information. As the individual cards are created, the information is either embedded in each card or is associated with each card. As a result of this process, content providers can create a plethora of cards having a wide variety of content and presentations.

It should be noted that the created cards are not necessarily limited to just product or service related cards. Additional cards that contain other information, such as details about specific sales or promotions, a story or history about the retailer, instructional information, product descriptions, specifications, support information, warranty information, maintenance or support information, or just about any other content covering just about any topic or subject matter imaginable may be created. Furthermore, the created cards may contain or cards including reference just about any type of media, including but not limited to, images, photos, text, video documents, etc.

In step 56, the content provider 14 (FIGS. 1 and 2) can select an existing wrap package template or define a new wrap template. Once a template is defined, it serves as a “blueprint” for the creation of personalized wrap packages 18 as described below.

At decision 58, the wrap environment 12 (FIGS. 1 and 2) can wait to receive data input from a user interface device 16 (FIG. 1) including identification information for a target recipient 20 (FIG. 1), a preferred delivery method (i.e., email or text) and one or more content title input(s).

At step 60, cards can be selected from the library 36 (FIG. 2) in response to receipt of the input recited in the previous step 58.

At optional step 62, personalized content for the target recipient can be generated or otherwise identified and/or defined.

At the next step 64, a personalized wrap package 18 (FIG. 1) for the target recipient 20 (FIG. 1) can be generated by assembling the cards selected per step 60 and arranging the selected cards in the same sequence order as defined by the wrap package template specified in step 54. In addition, optionally any custom content generated specific for the target recipient is inserted inline or referenced by any empty content component containers 46 (FIG. 4) provided in the cards of the wrap. As a result, a personalized wrap package 18 is generated with content specifically related to the content titles of interest to the target recipient 20.

At step 66, a wrap descriptor defining card descriptors for the cards (e.g., individual card descriptors for each of the cards) of the wrap package 18 can be generated. For more details on how wrap and card descriptors are generated, see U.S. Provisional Application No. 62/361,613, incorporated by reference herein for all purposes.

At step 68, the personalized wrap package 18 (FIG. 1) can be delivered to a user interface device (FIG. 1) associated with the target recipient 20 (FIG. 1) using the selected delivery method. For example, a Universal Resource Identifier (URL) identifying the wrap package 18 maybe embedded in an electronic message, such as an email or text, which is sent to the target 20. When the URL is selected, the corresponding wrap descriptor, which defines the wrap package 18, is delivered to the computing device of the target recipient 20. A runtime engine, at the computing device, is then responsible for generating a runtime instance of the wrap 18 from the wrap descriptor. In various embodiments, the runtime engine can be provided within a native application running on the consuming computing device or downloaded in cooperation with the wrap descriptor. For more details, see U.S. Provisional Application No. 62/361,613, incorporated herein by reference for all purposes.

For the sake of simplicity, the above discussion describes the generation of a single wrap package 18 (FIG. 1) for a single target recipient 20 (FIG. 1). It should be understood, however, that the same sequence can be repeated multiple times, resulting in generation of a multitude of personalized wrap packages 18 for a multitude of target recipients 20. Furthermore, multiple content providers 14 (FIGS. 1 and 2) can also use the system 10 (FIG. 1), and the wrap environment 12 (FIGS. 1 and 2), resulting in many more personalized wrap packages 18 distributed to even more target recipients 20.

### Card Selection

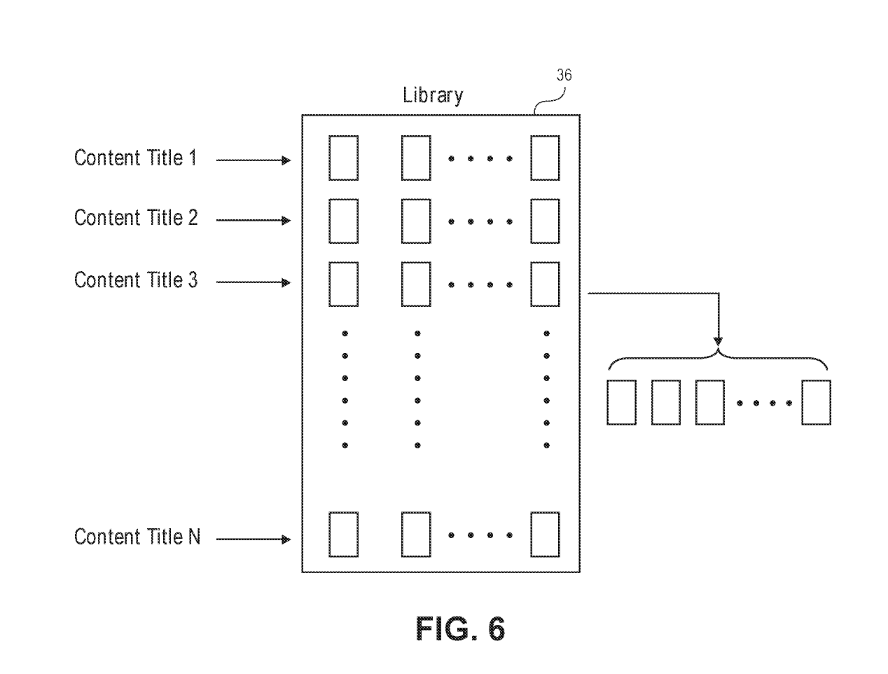

Referring to FIG. 6, a diagram illustrating how cards are selected (i.e., step 60 of FIG. 5) from the card library 36 (FIG. 2) in the creation of a personalized wrap package is illustrated. The cards are typically, although not necessarily, selected based on the selected content titles. For example, when one or more content titles is/are selected, an algorithm is used to select one or more cards pertinent to the selected content title(s). In other words, there is typically some relationship or nexus between the cards selected from the library 36 and the selected content title(s). For example, if a selected content title pertains to a product “A,” then cards relevant or pertinent to product “A” are selected. If the content titles pertain to product “A” and service “B,” then the selected cards will be relevant or pertinent to both A and B. In this manner, cards relevant to the selected content titles are selected and included in the personalized wrap package 18 (FIG. 1).

### Personalized Content

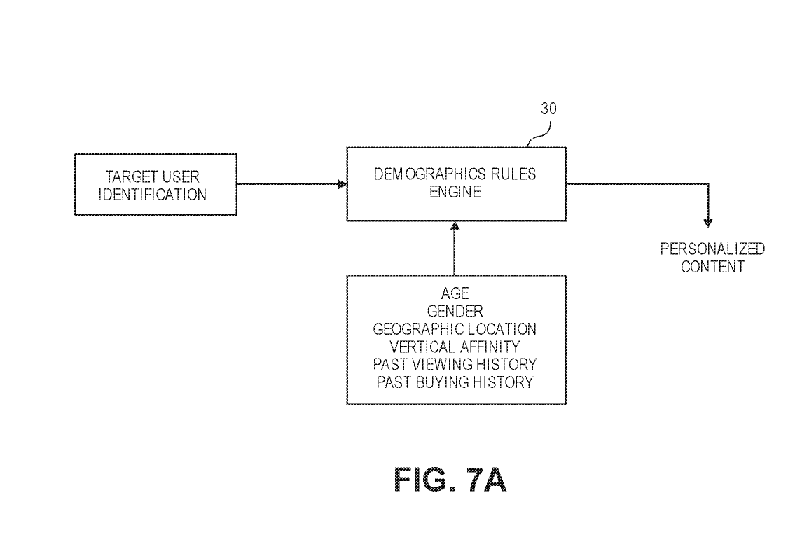

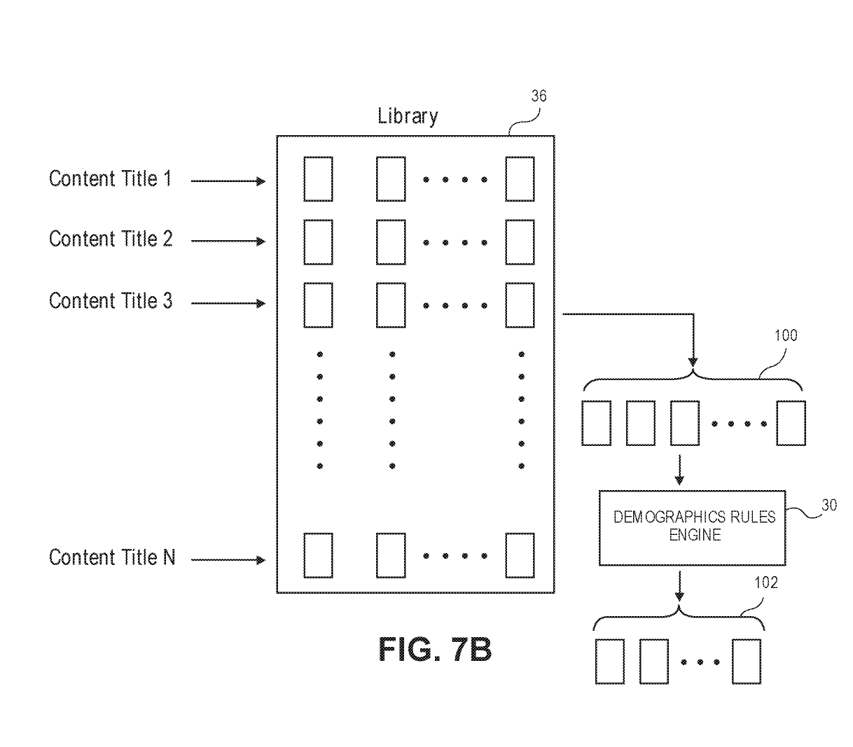

Referring to FIG. 7A, a diagram illustrating how personalized content is generated (i.e., optional step 62 in FIG. 5) within the guided selling system 10 (FIG. 1) is illustrated. In a non-exclusive embodiment, the demographic rules engine 30 may apply a set of rules that are pertinent to the identified target recipient 20 (FIG. 1). Such rules may include a number of considerations, such as the age, gender, geographic location, vertical affinity and past viewing and/or purchase history of the target recipient 20. Using these rules, personalized content, relevant to a target recipient 20, may be generated. As previously noted, the personalization information can be used within the empty content component containers 46 (FIG. 4) included in the various cards of a wrap package 18 sent to a given target 20.

### Card Selection Using Demographics

Referring to FIG. 7B, another non-exclusive embodiment showing the selection of cards for a personalized wrap package using both content title matching and demographics pertinent to a target recipient 20 (FIG. 1) is illustrated. In this embodiment, a set of cards 100 are first selected from the library 36 that match or otherwise share a nexus, relationship and/or commonality with the defined content titles as described above with respect to FIG. 6. Then, in a second step, demographics relevant to the target recipient 20 are applied to the select set of cards 100 by the demographics rule engine 30, similar to that described above with respect to FIG. 7A. The net result is a second set of cards 102 that are typically more relevant to a particular target 20 since demographics specific to the target is used in their selection.

### Example

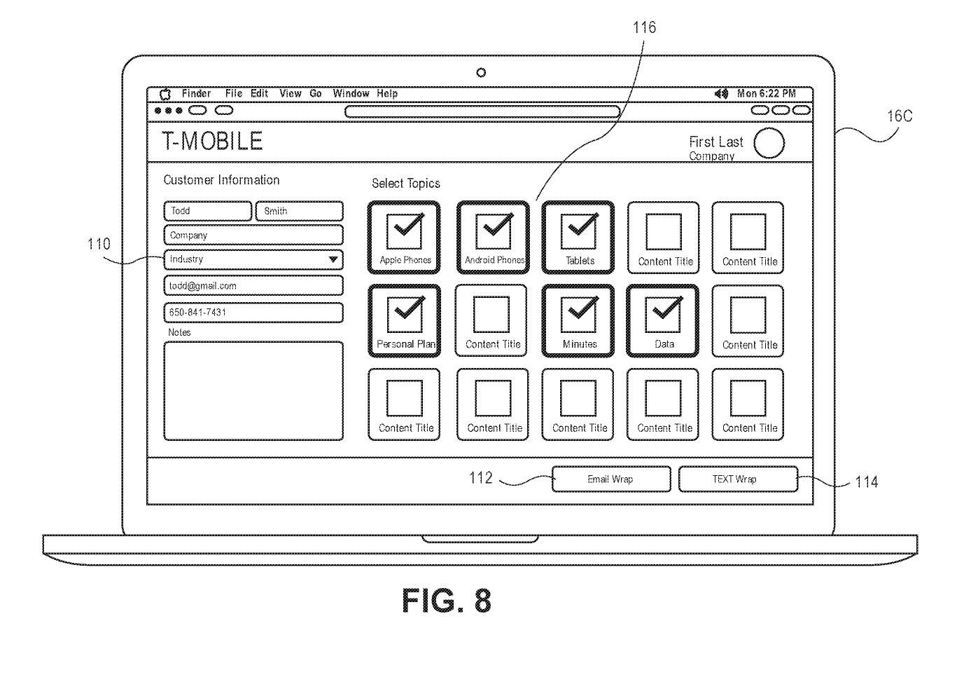

FIG. 8 depicts an exemplary user interface device 16 (FIG. 1). In this particular example, the user interface 16C is associated with T-Mobile, a well-known mobile phone service provider. On the display, a number of fields 110 are provided for entering information pertinent to a target recipient 20, such as their name, company, industry, contact information (telephone number and/or email address), and any notes or comments. In this particular example shown, the name of the target recipient is Todd Smith. The display also includes selection icons 112 and 114 for defining a delivery preference (e.g., email or text) for wrap packages 18 (FIG. 1). Finally, the display includes a number of content titles 116 specific or relevant to T-Mobile. The specific selected content titles include “Apple Phone,” Android Phones,” “Tablets,” Personal Plans, Minutes and Data. Once the above-described information is captured through the user interface device 16C, a personalized wrap package 18 for Todd Smith is generated containing content specific to the selected content titles is generated and delivered as described herein.

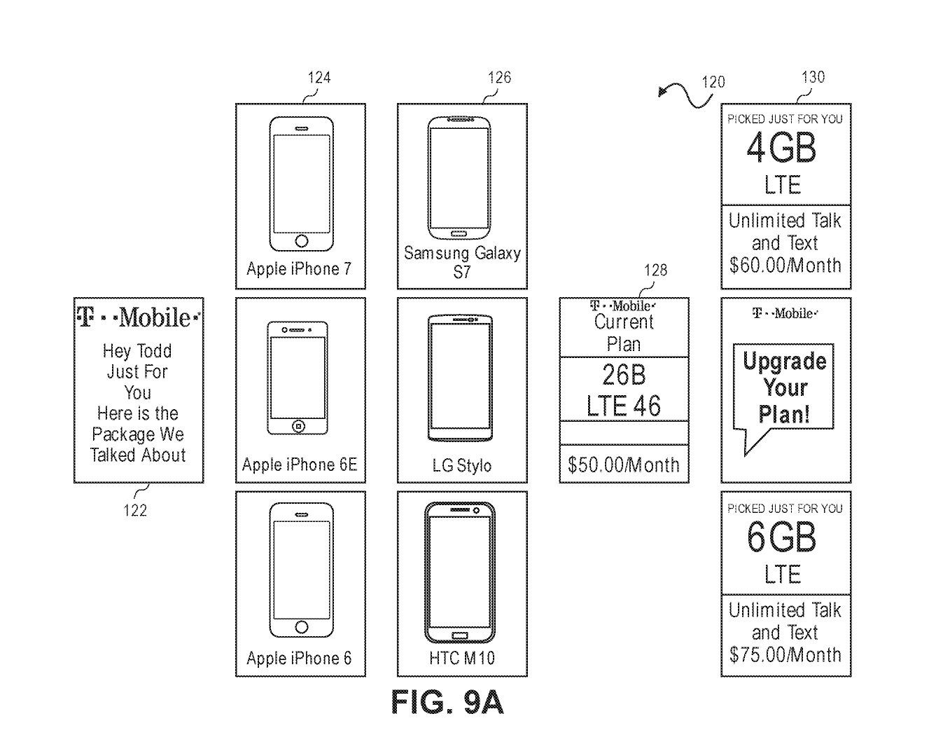

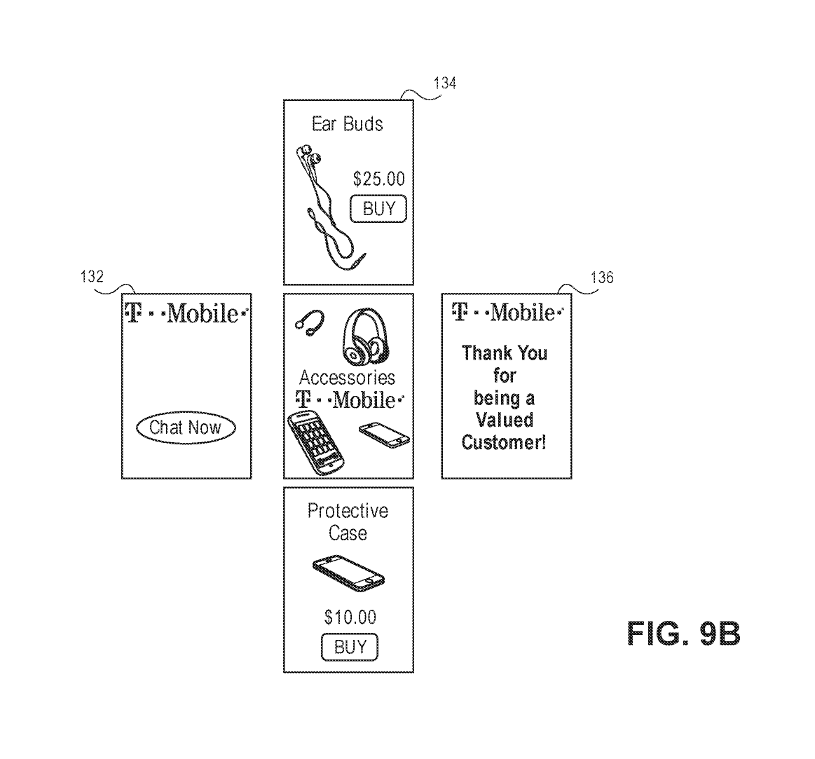

Referring to FIG. 9A and FIG. 9B, an exemplary personalized wrap package 120 generated for Todd Smith is illustrated. In this example, a first card 122 is an introduction card addressing Todd Smith by name and informing Todd the wrap package is from T-Mobile. The next two cards 124 and 126 are gallery cards each including galleries of Apple and Android phones respectively. The next card 128 is a personalized card including details on Todd's current mobile plan with T-Mobile. The subsequent card 130 is another gallery including a number of different upgrade plans offered by T-Mobile. The next card 132 (FIG. 9B) follows card 130 (FIG. 9A) and includes application functionality and allows Todd to initiate chat session with a customer representative of T-Mobile. Card 134 is a commerce gallery card that includes a number of gallery frames, each presenting a different ancillary product (e.g., ear buds, protective case, etc.) available for purchase through the wrap 120. Finally, the card 136 is an end of wrap card.

The above is provided as just one example of how a wrap can be generated with personal, contextual, content for a target recipient and that contains content addressing or relevant to the one or more selected content titles. It should be understood that in no way should this example be construed as limiting. As described above, a personalized wrap package can be generated and delivered to any target recipient containing a wide variety of content and functionality and may address just about any content titles therein.

### Wrap and Card Descriptors

In non-exclusive embodiments, wrap packages 18 are portable electronic documents that can be easily transported over electronic networks. In various non-exclusive embodiments, such wrap package documents are represented by a descriptor, sometimes referred herein as a “wrap descriptor”.

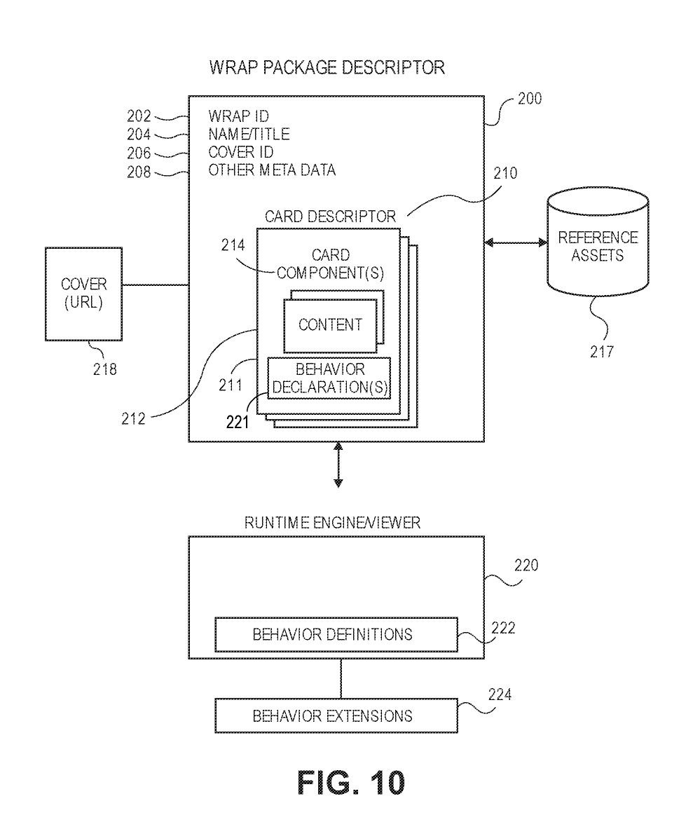

Referring to FIG. 10 a block diagram of a wrap package descriptor 200 used to represent a wrap package 18 (FIG. 1) is illustrated. The wrap package descriptor 200 includes a unique wrap identifier or ID 202 used to identify the corresponding wrap package, an optional wrap name or title 204, an optional cover identifier or ID 206, and other meta data 208, such as but not limited to a date the wrap was created, the author name, version of the wrap, etc.

The wrap package descriptor 200 also typically includes a plurality of card descriptors 210 for the cards (e.g., one or more card descriptors for each of the cards) in the wrap package. Each card descriptor 210 typically defines a card component container 212 that defines the aspect ratio for the associated card. In addition, each card descriptor 210 also typically includes one or more content component containers 214 for containing or referencing content either inline or by referencing the content located in a remote asset store 217. In general, each component 214 is maintained in a fixed relative position within the fixed aspect ratio of the associated card defined by the card component container 212. Thus, by using content component(s) 214 within a card component container 212, a fixed presentation of each card is maintained, regardless of the size and/or orientation of the consuming computing device.

In many instances, much of the actual content of the wrap is referenced by the wrap descriptor 200 and/or card descriptor(s) 210 rather than being stored in-line. However, the balance between in-line storage and references to external assets in any particular wrap descriptor may be widely varied anywhere from 100% referenced content to (at least theoretically) to 100% in-line content— although the later is less desirable for media rich content and again, begins to defeat some of the advantages of using the descriptor approach. The choice between in-line and referenced content will typically be dictated, in large part, by the relative size of the content. For example, text, which tends to be very compact, is generally more suitable for inclusion in-line, whereas more graphic media, images, videos and/or audio files are typically more efficiently referenced.

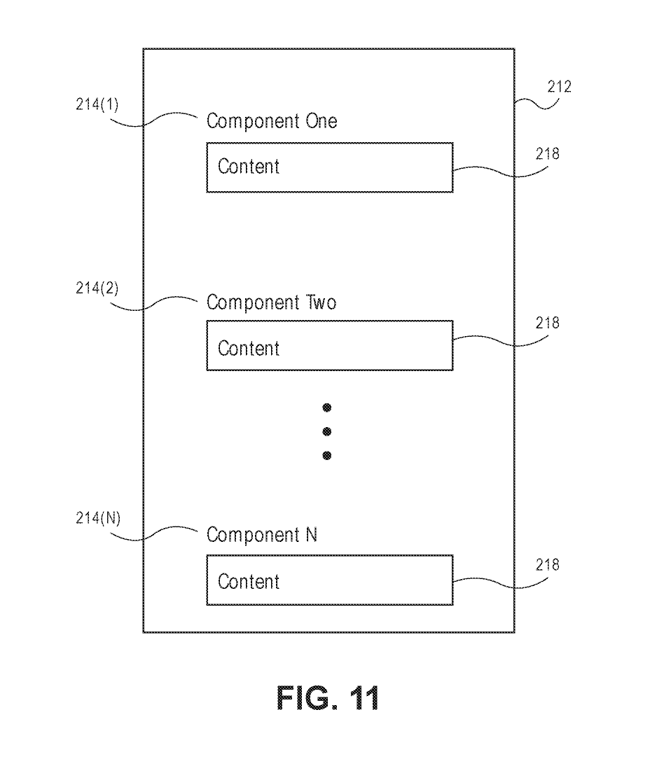

Referring to FIG. 11, a block diagram illustrating a non-gallery card component container 212. In this embodiment, the card component container 212 has an aspect ratio that is substantially the same or similar to the aspect ratio of the display used on most mobile phones. As such, the aspect ratio of the corresponding card, in this non-exclusive example, is essentially fixed to match the display of mobile phones. In addition, the card component container 212 further includes one or more content component containers 214(1) through 214 (N), each having a fixed relative position within the fixed aspect ratio of the card. By using this approach, the presentation of the card, as the author originally intended, remains the same regardless of the size, type, class and/or orientation (e.g., landscape, portrait, etc.) of the display associated with the consuming device.

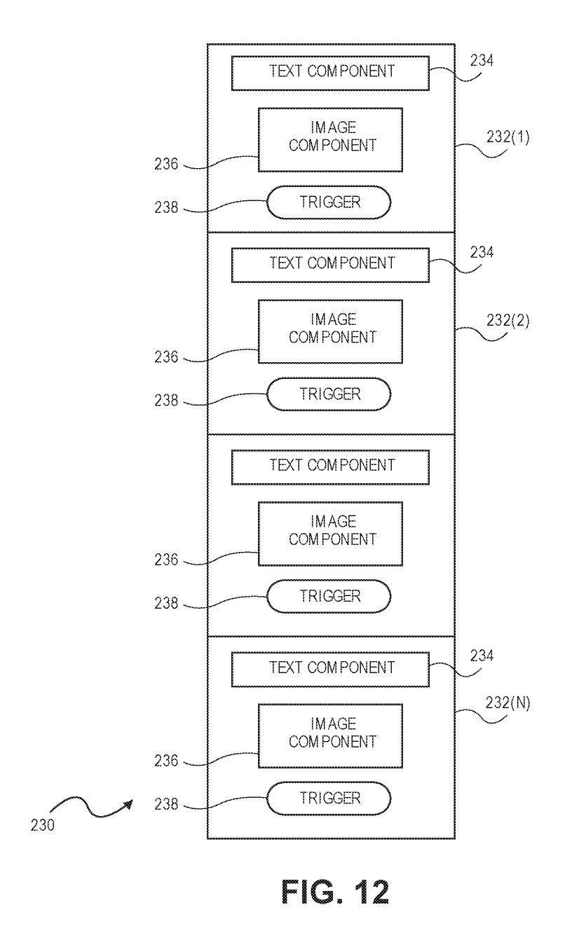

Referring to FIG. 12, a block diagram including one or more components used to represent a gallery card container 230 is illustrated. In this embodiment, the gallery card container 230 includes a plurality of gallery frames 232(1) through 232(N) (hereinafter collectively referred to as 232) each having a fixed aspect ratio. Within each gallery frame 232, one or more content component containers may be included, again each having a fixed relative position within each gallery frame 232. In this particular example, each gallery frame 232 includes a text component 234, an image component 236 and a trigger component 238. With this approach, a galley card will typically have the same width as a non-gallery card, but the length will be substantially longer, depending on the number of gallery frames 232. In addition, the presentation of each gallery frame 232 remains the same, with the aspect ratio and relative layout of content fixed, again regardless of the rendering environment.

In various alternative embodiments, the aspect of the non-gallery card component containers 212 (FIG. 11) and the gallery card 230 may assume any ratio and are not limited to match that of mobile phones for example. On the contrary, any desired aspect ratio can be used. In addition, the content included in any component container may also widely vary and include text, an image or photo, a video a widget, application functionality such as reservation, booking or appointment making functionality, GPS or positional functionality, transactional functionality, a link, a document and/or a call-to-action trigger. Again, by using the wrap and card descriptor approach, with various levels of components, the presentation of a wrap will remain consistent, regardless of the rendering environment.

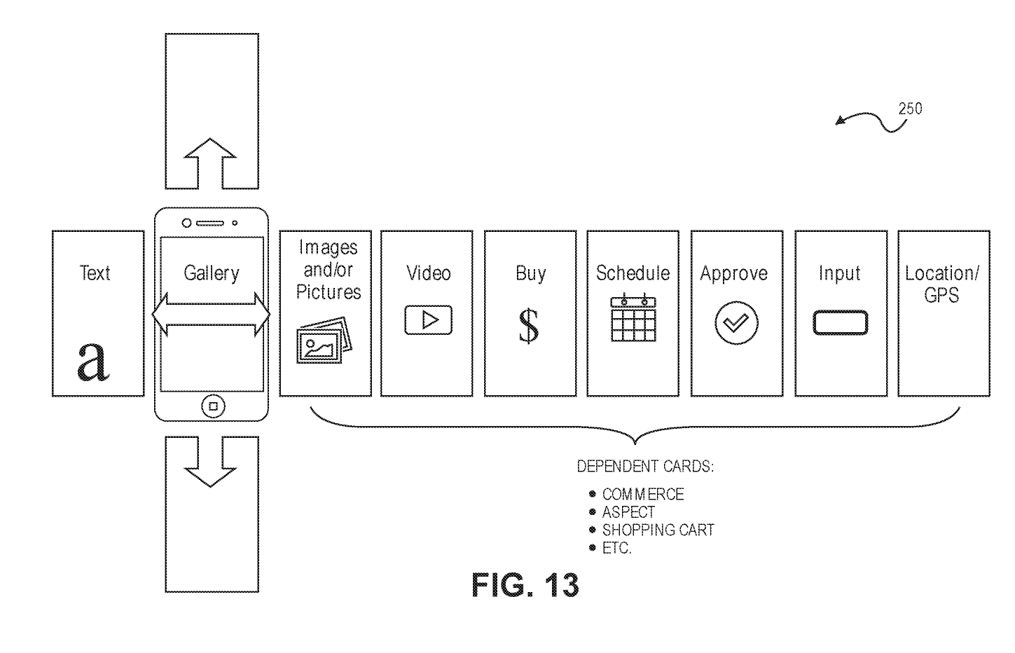

Referring to FIG. 13, a representative wrap package 250, created using the above-described personalization process, is illustrated. In this particular example, the wrap package 250 is navigable in two linear directions, including horizontally and vertically. In particular, inter-card navigation among a plurality of non-gallery cards occurs along the horizontal direction, while intra-card navigation of the gallery card occurs along the vertical direction, both in response to navigable inputs. It should be understood that this example is merely illustrative. For a given wrap, the arrangement and number of non-gallery and gallery cards, and the directions in which both intra and inter card navigation may occur, is virtually limitless.

Furthermore, the various cards of the wrap package may include a wide arrangement of media content, application functionality and e-commerce related services, including but not limited to text, a gallery of gallery items, images and/or photos, video, transactional functionality, appointment, booking or reservation function, an approval function, a user input function and/or location or GIPS functionality. Again, these are just a few examples of the types of cards, application functionality and e-commerce related services that may be included in a given wrap package.

The cards of a wrap thus have a visual representation intended to evoke similarities to their physical counterparts. They each have their own fixed portrait aspect ratio that makes them ideally suited to current mobile computing devices. In addition, the cards of a given wrap are also all scalable, to the same degree, so that they can also be easily rendered on other displays, regardless of their size, orientation or form factor, while preferably always maintaining the same presentation. The physical card metaphor can also extend to the interactive behavior of cards in a wrap, as the user can use gestures that evoke the “flipping” of cards in a deck or bound booklet to navigate between them.

Cards, however, however can differ from their physical counter-parts in ways that provide for unique presentations of content or the aforementioned interactive services. For example, a gallery card provides the ability to present an expanded amount of content in a vertically stacked orientation such that the overall length (i.e., the number of cards in a horizontal sequence) of the wrap is not affected by the amount of content in the wrap. This aids in navigation since the user can flip to the previous or next card regardless of their current position in the gallery.

Furthermore, cards are like containers for holding and distributing media content, such as text, images, photos, audio, video and the like. In addition, cards may also contain or hold executable objects that provide or enable real-time features, such as application functionality (i.e., the ability to schedule appointments, engage in online chats or conversations) and support e-commerce related services (i.e., the ability to purchase products and/or services). Such media content and executable objects are sometimes referred to herein as card “assets.”

Cards are also consumable anywhere, meaning they have the ability to be resolved and displayed on just about any type of device (mobile phones, laptops, tablets, wearable computing devices such as smart watches, desktop computers, smart TVs, etc.), regardless of the platform (e.g., iOS, Android, Microsoft, etc.).

### Wrap Delivery and Runtime Engine

Referring again to FIG. 10, a wrap cover 218 containing a Uniform Resource Identifier or URL that includes or otherwise embeds the wrap identifier 202 may be used in the distribution of a wrap package 18 (FIG. 1) in certain non-exclusive embodiments. For example, the wrap cover 218 may be a visually appealing graphic image or photo embedded within an email, text message, or other electronic message. When the wrap cover 218 is selected, a request for the wrap package 18 is made using the wrap identifier 202. In return, the wrap descriptor 200 is returned to the requesting device. In alternative embodiments, a URL without a wrap cover 218 including the wrap identifier 202 may be distributed or otherwise included in a link provided in an email, or other electronic message.

In one non-exclusive embodiment, a runtime engine 220 is also delivered to the requesting device along with the wrap descriptor 200. With this embodiment, when a request is made for the wrap descriptor 200, a markup language shim is delivered to the requesting device, which is then transformed into a browser window on the requesting device. Thereafter, the runtime engine 220 is delivered followed by the wrap descriptor 200. The delivered runtime engine de-serializes the wrap descriptor, initially generating an object graph and then a Document Object Model (“DOM”) from the object graph. The runtime viewer 220 then cooperates with the browser on the requesting device to generate a runtime instance of the wrap package in the browser page based on the DOM.

This two-step approach differs from how conventional web pages are usually processed and displayed. Typically, the browser on a consuming device will convert Hyper Text Markup Language (HTML) defining a web page into a DOM, which is then used by the browser to directly display the web page. There is no intermediate transformation step of converting a “raw” wrap descriptor into an object graph prior to the browser displaying content based on a DOM. For more detail related to this discussion, see U.S. Provisional Application 62/361,613 entitled “Card Based Package for Distributing Electronic Media,” filed Jul. 13, 2016, and incorporated by reference herein for all purposes.

In an alternative embodiment, the runtime engine 220 may already reside at the consuming device, typically either locally cached as a result of a previous wrap viewing or in the form of an already installed native application. In this latter embodiment, a number of the previously described steps can be eliminated. For instance, the runtime instance of the wrap package can be directly generated from the wrap descriptor without having to deliver a shim, open a browser page, or generate an object graph.

In addition, the runtime engine, regardless of the embodiment, creates a card list in the sequence order(s) from the wrap descriptor and provides navigation tools that operate in cooperation with the browser to facilitate transitioning between cards during consumption. In non-exclusive embodiments, the order of the cards is implicit in the descriptor structure. Since the navigation functionality is provided by the runtime viewer, the cards do not have to include navigational constructs. That is, there is no need to provide explicit linking or navigation components in the cards to facilitate normal navigation between adjacent cards in the wrap, which helps simplify card design. Since the runtime viewer in cooperation with the browser handle card navigation, the cards only require navigational constructs when the author desires to override the standard wrap navigational features. This allows wrap authors to concentrate on creating the desired content and visual appearance of their wraps, without needing to worry about the platform dependent formatting or navigation requirements. In other embodiments, however, cards may include navigational constructs that operate either in place of or in cooperation with the navigation tools provided by the runtime viewer.

The runtime engine 220 typically will also include navigation tools that enable transitions from card to card within the wrap package in response to either a navigable input (e.g., a screen swipe or other input) or, alternatively, in response to some other trigger event, such as the selection of a BUY button which triggers the presentation of a dependent card for instance.

The navigation tools that are actually used for any particular wrap instance can be device and/or platform dependent. For example, swipe navigation is preferably facilitated when the consuming device has a touch sensitive screen, as is popular in most mobile computing devices such as smartphones and tablet computers. Selectable GUI navigation buttons (such as arrows, buttons, text-based swipe directions, etc.) may also be displayed on the screen to facilitate navigation between cards. In addition, non-touch screen based navigation may be facilitated when the consuming device has as a selection device (e.g., a mouse) and/or a keyboard or keypad where various keys (e.g., right, left, up and down arrow keys, etc.) may be used to navigate between cards.

### Card Behaviors

In yet other non-exclusive embodiments, a behavior declaration 221 can also be included in a card descriptor 210 for imbuing a certain desired behavior with the associated card at runtime. For instance, an author of the wrap may wish a gallery card to be imbued with either a “continuous scrolling” or “snap-to-frame” behavior in response to navigable inputs. By declaring either option in the card descriptor 210, the desired behavior is imbued by the runtime engine 220 by assigning the appropriate behavior definition to the card among a library 222 of behavior definitions. With this approach, the desired card behavior can be assigned to the card at runtime without having the include scripts or other code in the wrap descriptor 200 and/or card descriptors 210, which helps simplify the descriptor structure and make them easier to distribute over wireless networks. In yet another variation of this embodiment, a declared behavior contained in a card descriptor 210 may not have a corresponding behavior declaration in the library 222. In which case, the runtime engine 220 may access a remote behavior extension store 224 to obtain the corresponding behavior definition.

### JSON and XML

Wrap descriptors 200 can be represented in a number of different formats. For instance, a wrap descriptor 200 may be formatted using markup languages, such as XML, which are common formats used for the distribution of web content and functionality. Although markup languages can be used to represent a wrap, the Applicant has found that using a JavaScript Object Notation (JSON) format for representing wrap descriptors 200 works particularly well for defining a wrap package of cards. As explained in detail below, the use of JSON results in wrap descriptors 200 that are generally more compact and concise and that are simpler to produce, transport and consume compared to using a markup language.

JSON is a lightweight, text-based, language independent data interchange format. Although JSON is a well known for exchanging data, to the best of the knowledge of the Applicant, JSON has not previously or conventionally been used to define the entire structure, layout and content of web based cards or even web pages and it has not been used to represent the structure, layout and content of a set of cards such as wrap packages as described herein. On the contrary, conventional wisdom suggests that markup languages (in conjunction with style sheets—e.g. CSS) are the most suitable medium for defining the content and presentation of web based documents, including both traditional web pages and web-based cards. However, applicants have found that the use of descriptors in general, and the use of JSON descriptors in particular, has several advantages when representing a set of cards of a wrap package when compared to using markup language card definitions. Thus, the representation of a wrap package may be stored as a JSON data object. That is, a wrap descriptor 200 may take the form of a JSON object. In other embodiments, a BSON (Binary JSON) data object may be used. Although the use of JSON or BSON data objects is described, it should be appreciated that in other embodiments, a given wrap package may be stored in a variety of other suitable formats, whether now existing or later developed.

One advantage of using JSON is that in the context of defining the structure, layout and content of a set of cards, JSON tends to be more compact than XML and other popular markup languages.

Another advantage of using JSON relates to portability. Since JSON is derived from JavaScript, the JavaScript parser associated with virtually any JavaScript interpreter can seamlessly parse the JSON. Today, JavaScript interpreters are ubiquitous and included in virtually all web browsers and web based viewers which simplifies (and reduces the size of) the runtime viewer 220 since there is no need to include a dedicated descriptor parser. In contrast, if XML is used to create the descriptor, many runtime environments would need to be supplemented by an appropriate XML parser.

JSON's ability to express typed data, and especially arrays, also has benefits in the context of a wrap descriptor. Consider, for example, the JSON expression:
“cards”:[ . . . ]
   This expression communicates that the defined structure is an array of “cards”. The communication of data type, especially arrays, is beneficial within the context of wrap packages because wrap descriptors may contain repeating elements where implicit order is important. In the example, the expression “cards”: [ . . . ] is used to define the set of cards that constitute the wrap as can be seen, for example, in the Appendices of the incorporated U.S. Provisional Application No. 62/325,373. The implicit order of the array elements (i.e., the order of the cards in the array) is then used by the runtime viewer to define the order of the cards within the runtime instance of the wrap package. That is, the order of the cards in the package is implicitly defined by the wrap descriptor. In contrast, defining the order of a set of cards using traditional markup language approach, without explicit card-to-card links, is more cumbersome.

In addition, JSON's inherent ability to represent arrays of raw/structured data is advantageously used to concisely define a wrap package of cards. Specifically, in some embodiments, wrap descriptors may be organized as a nested array structure. With a given wrap descriptor for instance, an array of cards, each defined by a card component, is defined in a predefined sequence for browsing. For each card, a sub-array of one or more component(s) is typically defined. For any given component, yet another sub-array of sub-component(s) may optionally be defined. Thus, this hierarchical approach (i.e., wrap descriptor—card descriptors—card components—asset components, etc.), intrinsically lends itself to JSON's native ability to represent arrays. As a result, a very compact, concise data structure representative of a wrap package results. In contrast, most traditional markup languages such as XML do not natively support arrays, and consequently, would likely result in a less concise representation.

In addition, the use of JSON also has potential advantages from a security standpoint. Most notably, since JSON is intended as a data interchange format, it does not have a facility for handling executable scripts such as JavaScript. In contrast, many mark-up languages, including HTML, have the facility for inclusion of executable scripts such as JavaScript, which allows web sites authors to incorporate interactive features into their websites through the use of scripts. However, a drawback of allowing JavaScript execution within a web page is that it complicates the security architecture of the encapsulating browser in part because of the risk of a webpage, knowingly or unknowingly, including malicious scripts. In contrast, even if malicious scripts were introduced into a JSON wrap descriptor, they would typically be ignored by the runtime JSON de-serializer since the is no mechanism to interpret such scripts. Thus, the fact that JSON does not natively facilitate the use of inline scripts keeps the security model very simple within the wrap ecosystem.

In some embodiments, behaviors are declared in the wrap descriptor and the runtime viewer has, or knows how to obtain, the associated behavior definitions. This allows wrap authors to instill wraps with a variety of functionality and interactive features without requiring the author to script the desired functionality. This helps reduce the possibility of errors being introduced by inexperienced wrap authors and generally simplifies the process of authoring compelling wraps with a variety of desired functionality.

It is noted that in various alternative embodiments, wrap descriptors could also potentially be modified to support the use of scripts in a JSON object. In such embodiments, however, a customized runtime de-serializer would be needed to interpret such scripts and some of the security benefits of using JSON would potentially be reduced.

Furthermore, although its primary purpose is markup, it should be appreciated that XML can also be used for data exchange, and therefore, to represent wrap descriptors and/or card descriptors. As such XML wrap descriptors and card descriptors could readily be used.

A few different methods of and architectures for serving wrap packages and constructing runtime instances have been described herein. Although only a few approaches have been described in detail, it should be apparent from the foregoing that a wide variety other methods and architectures can be used as well. Therefore, the present embodiments should be considered illustrative and not restrictive and the invention is not to be limited to the details given herein, but may be modified within the scope and equivalents of the appended claims.

What is claimed is:

1. A method of generating and delivering a wrap package of cards comprising:
receiving data input from an input device, the data input including identification of a target recipient and one or more content titles;
selecting, responsive to receiving the data input, one or more cards, from a library of cards, pertinent to the one or more content titles;
assembling the wrap package of cards, the wrap package of cards including the one or more cards selected from the library of cards and personalized with content pertinent to the identified target recipient;
generating a document descriptor that represents the wrap package of cards; and
providing, using a communication network, the document descriptor being used by a computing device associated with the target recipient, the document descriptor used at the computing device to generate a runtime instance of the wrap package of cards.

2. The method of claim 1, wherein the wrap package of cards is derived using a template specifying one or more of:
a card sequence order for the wrap package of cards;
one or more card place holders for defining a respective place in the sequence order for each of the one or more electronic cards selected from the library of cards; and
one or more empty content component containers for at least one of including and referencing the content pertinent to the identified target recipient.

3. The method of claim 2, wherein the card sequence order extends horizontally, vertically, or both horizontally and vertically.

4. The method of claim 1, wherein assembly of the wrap package of cards further comprises inserting the one or more cards, selected from the library of cards, into placeholder locations within a wrap package template and inserting the content pertinent to the identified target recipient into empty content component containers of the one or more cards.

5. The method of claim 1, wherein generating the document descriptor for the wrap package of cards comprises generating card descriptors for the cards of the wrap package of cards.

6. The method of claim 5, wherein the card descriptors for the cards of the wrap package of cards use JavaScript Object Notation (JSON) to at least partially represent the cards of the wrap package of cards.

7. The method of claim 5, wherein the card descriptors for the cards include:
a card component container that defines a fixed aspect ratio for the associated card; and
one or more content component containers for maintaining content, in a fixed relative position, within the fixed aspect ratio defined by the card component container.

8. The method of claim 1, wherein the cards of the wrap package of cards include at least one of an orientation of a display device associated with a consuming device, a type of a display associated with the consuming device, a scaling for each card, an aspect ratio, and relative layout of content for rendering the wrap package.

9. The method of claim 5, wherein the document descriptor does not include markup language tags, scripts, and other executable code used to represent the cards of the wrap package of cards or to implement functionality included in or associated with the cards of the wrap package of cards.

10. The method of claim 5, wherein at least one of the card descriptors includes a behavior declaration, the behavior declaration binding a corresponding behavior to the associated card at runtime when the card associated with the at least one card descriptor is rendered.

11. The method of claim 1, wherein the wrap package of cards includes a gallery card, the gallery card comprising a plurality of gallery items arranged sequentially along a first direction in response to navigable inputs.

12. The method of claim 11, wherein the wrap package of cards further includes a plurality of non-gallery cards, the plurality of non-gallery cards arranged for sequential rendering along a second direction, the second direction being perpendicular to the first direction.

13. The method of claim 12, wherein the gallery card and the plurality of non-gallery cards have a common first dimension and have different second dimensions.

14. The method of claim 1, further comprising applying a set of demographic rules when defining the personalized content for the identified target recipient, the demographic rules associated with the identified target recipient.

15. The method of claim 1, further comprising providing an authoring environment for authoring the library of cards and one or more wrap package templates.

16. The method of claim 1, wherein the wrap package of cards further includes at least one commerce card, the commerce card being operable by the target recipient to purchase a product or service presented in the wrap package of cards when rendered on the computing device.

17. The method of claim 16, wherein the purchase, is performed using the wrap package of cards by:
presenting to the target recipient, through the at least one commerce card, access to a payment gateway associated with an e-commerce platform, the target recipient completing the purchase within the wrap package of cards using the accessed payment gateway.

18. The method of claim 16, wherein the target recipient completing the purchase further comprises at least one of:
one or more dependent cards in the wrap package of cards for processing and completing the purchase in cooperation with an e-commerce platform;
a widget in the at least one commerce card, the widget cooperating with the remote e-commerce platform to process and complete the purchase; and
switching from the at least one commerce card to an e-commerce web site associated with the e-commerce platform and returning to the wrap package when the purchase is complete.

19. The method of claim 1, wherein the data input received from the input device includes at least one of the following:
identification information identifying the target recipient; and
a delivery preference for delivering the wrap package of cards.

20. The method of claim 1, wherein:
the input device is associated with a content provider and the data input is entered by a representative of the content provider on behalf of the target recipient;
the input device is associated with the target recipient and the target recipient enters the data input using the input device;
the input device is associated with the content provider and the data input is entered by the target recipient having access to the input device; and
the data input is inferred using online content the target recipient is viewing.

21. The method of claim 1, wherein the one or more cards are selected from the library of cards using commonality with the one or more content titles and demographics associated with the target recipient.

22. A method of generating and delivering a wrapped package of cards comprising:
receiving, during a customer contact at a customer support center of a provider, data from the customer, the data including customer contact information, an inquiry regarding at least one of a product and service offered by the provider, and a delivery preference;
generating a wrap package of cards responsive to receiving the data, the wrap package of cards including one or more cards presenting media pertinent to the at least one of the product and service; and
providing the wrap package of cards to a computing device associated with the customer, the computing device generating and rendering a runtime instance of the wrap package of cards, such that each of the cards of the wrap package of cards maintains a predetermined proportion when the wrap package of cards is rendered, the predetermined proportion being maintained for each card by a card component container defining a fixed aspect ratio for each card and one or more content component containers for presenting the media in a fixed relative position within the fixed aspect ratio of each card component container, a displayed proportion of each card of the wrap package of cards remaining constant when rendered on displays of different sizes and/or orientations associated with different types of consuming computing devices.

23. An apparatus for generating and delivering a wrap package of cards comprising:
a processor; and
a memory communicatively coupled to the processor, the memory storing instructions executable by the processor to perform a method, the method comprising:
receiving data input from an input device, the data input including identification of a target recipient and one or more content titles;
selecting, responsive to receiving the data input, one or more cards, from a library of cards, pertinent to the one or more content titles;
assembling the wrap package of cards, the wrap package of cards including the one or more cards selected from the library of cards and personalized with content pertinent to the identified target recipient;
generating a document descriptor that represents the wrap package of cards; and
providing, using a communication network, the document descriptor to a computing device associated with the target recipient, the document descriptor being used by the computing device to generate a runtime instance of the wrap package.

24. An apparatus for generating and delivering a wrapped package of cards comprising:
a processor; and
a memory communicatively coupled to the processor, the memory storing instructions executable by the processor to perform a method, the method comprising:
receiving, during a customer contact at a customer support center of a provider, data from the customer, the data including customer contact information, an inquiry regarding at least one of a product and service offered by the provider, and a delivery preference;
generating a wrap package of cards responsive to receiving the data, the wrap package of cards including one or more cards presenting media pertinent to the at least one of the product and service; and
providing the wrap package to a computing device associated with the customer, the computing device generating and rendering a runtime instance of the wrap package, such that each of the cards of the wrap package maintains a predetermined proportion when the wrap package of cards is rendered, the predetermined proportion being maintained for each card by a card component container defining a fixed aspect ratio for each card and one or more content component containers for presenting the media in a fixed relative position within the fixed aspect ratio of each card component container, a displayed proportion of each card of the wrap package of cards remaining the same when rendered on displays of different sizes and/or orientations associated with different types of consuming computing devices.
